(19) United States
(12) Patent Application Publication
(10) Pub. No.: US 2017/0297487 A1
(43) Pub. Date: Oct. 19, 2017

(54) VEHICLE DOOR OPENING ASSESSMENTS

(71) Applicant: GM GLOBAL TECHNOLOGY OPERATIONS LLC, Detroit, MI (US)

(72) Inventors: MAQSOOD RIZWAN ALI KHAN, ROCHESTER HILLS, MI (US); MARK R. CLAYWELL, BIRMINGHAM, MI (US); PULASTI BANDARA, CLINTON TOWNSHIP, MI (US)

(73) Assignee: GM GLOBAL TECHNOLOGY OPERATIONS LLC, Detroit, MI (US)

(21) Appl. No.: 15/099,417

(22) Filed: Apr. 14, 2016

(51) Int. Cl. B60Q 9/00; E05F 15/40; G08G 1/16

(52) U.S. Cl. CPC B60Q 9/008; G08G 1/168; E05F 15/40; G08G 1/165; E05Y 2900/531

(57) ABSTRACT

Methods, systems, and vehicles are provided for determining whether one or more doors of a vehicle are expected to contact the one or more objects when opened. In accordance with one embodiment, the vehicle includes, in addition to the one or more doors, one or more sensors, a memory, and a processor. The one or more sensors are configured to generate sensor data pertaining to one or more objects in proximity to a vehicle. The memory is configured to store a door geometry for the one or more doors. The processor is coupled to the one or more sensors and to the memory, and is configured to at least facilitate determining whether the one or more doors are expected to contact the one or more objects when opened, using the sensor data and the door geometry.

### TECHNICAL FIELD

The present disclosure generally relates to vehicles, and more particularly relates to methods and systems for assessing the possible opening of vehicle doors.

### BACKGROUND

When a vehicle is parked, one consideration of parking is having sufficient room to maneuver in and out of the vehicle. However, in certain situations there may be limited room to open vehicle doors, for example when the vehicle is parked in certain locations.

Accordingly, it is desirable to provide techniques for assessment of vehicle door openings. It is also desirable to provide methods, systems, and vehicles utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided. The method comprises obtaining, via one or more sensors, sensor data pertaining to one or more objects in proximity to a vehicle, obtaining a door geometry for one or more doors of the vehicle, and determining, via a processor, whether the one or more doors are expected to contact the one or more objects when opened, using the sensor data and the door geometry.

In accordance with another exemplary embodiment, a system is provided. The system comprises one or more sensors, a memory, and a processor. The one or more sensors are configured to generate sensor data pertaining to one or more objects in proximity to a vehicle. The memory is configured to store a door geometry for one or more doors of the vehicle. The processor is coupled to the one or more sensors and to the memory, and is configured to at least facilitate determining whether the one or more doors are expected to contact the one or more objects when opened, using the sensor data and the door geometry.

In accordance with a further exemplary embodiment, a vehicle is provided. The vehicle comprises one or more doors, one or more sensors, a memory, and a processor. The one or more sensors are configured to generate sensor data pertaining to one or more objects in proximity to a vehicle. The memory is configured to store a door geometry for the one or more doors. The processor is coupled to the one or more sensors and to the memory, and is configured to at least facilitate determining whether the one or more doors are expected to contact the one or more objects when opened, using the sensor data and the door geometry.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes doors in addition to a system for assessing opening of the doors of the vehicle, in accordance with an exemplary embodiment;

FIG. 2 is a flowchart of a process for assessing opening of vehicle doors, and that can be implemented in connection with the vehicle of FIG. 1, in accordance with an exemplary embodiment; and

FIG. 3 is a depiction of an exemplary display of an assessment of vehicle door openings, and that can be implemented in connection with the vehicle of FIG. 1 and the process of FIG. 2, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

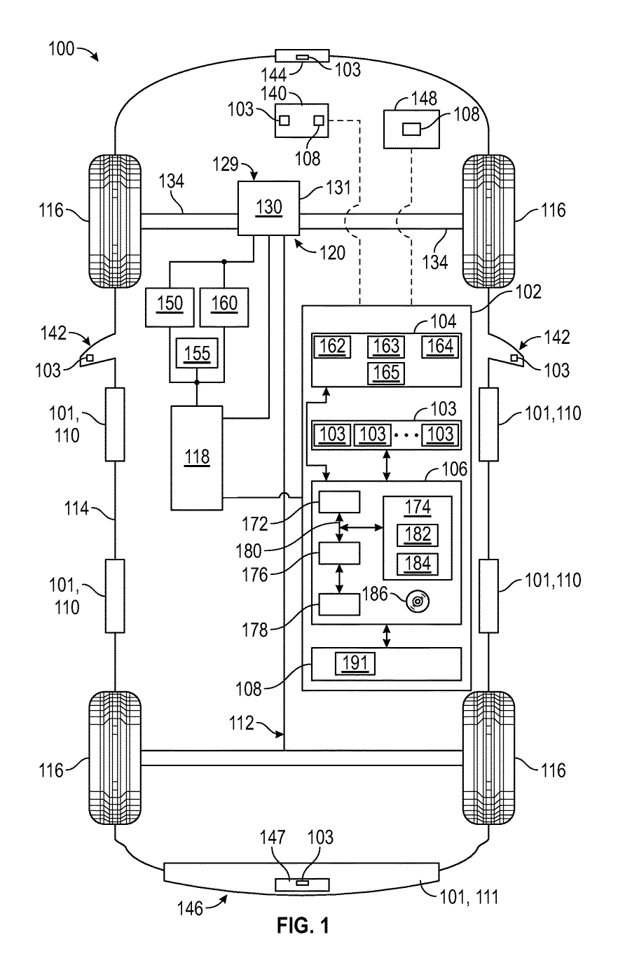

FIG. 1 illustrates a vehicle 100, or automobile, according to an exemplary embodiment. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD).

As described in greater detail further below, the vehicle 100 includes various doors 101 as well as a control system 102 for assessing opening of the doors 101. In the depicted embodiment, the doors 101 include side doors 110 on the driver's side and passenger's side of the vehicle 100 as well as a rear door 111 in a rear portion 146 of the vehicle 100. In one embodiment, the rear door 111 comprises a rear hatch for the vehicle 100. In other embodiments, the rear door 111 may comprise a trunk door and/or other type of rear door. It will be appreciated that the number and/or configuration of doors 101 may vary in different embodiments.

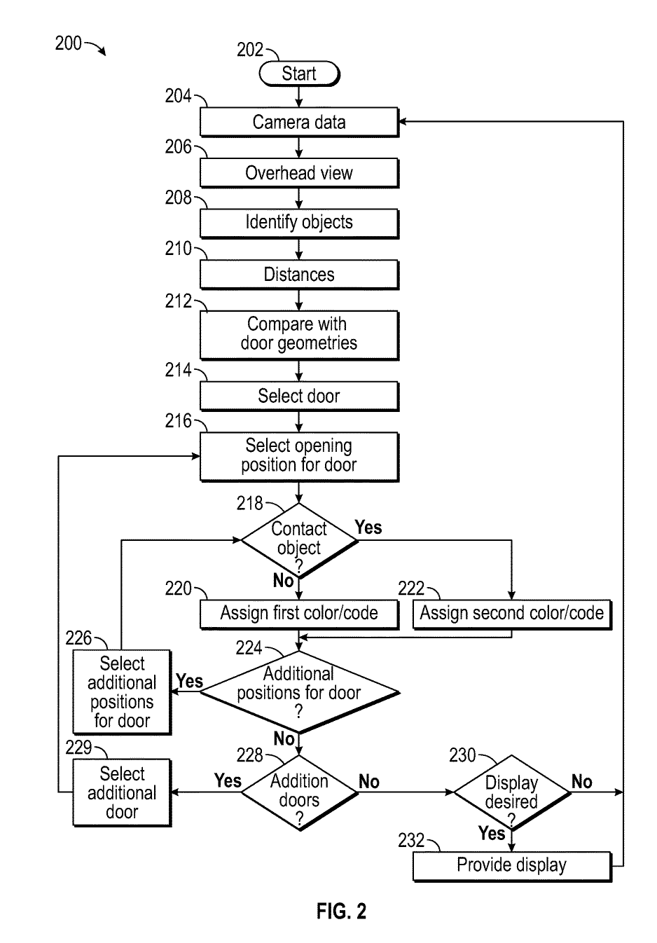

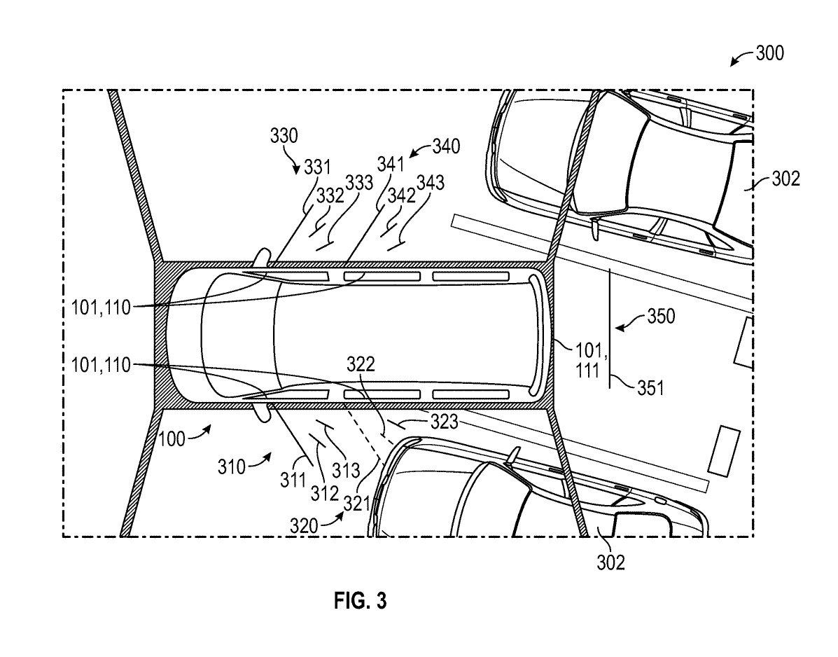

Also as discussed further below, the control system 102 includes a plurality of cameras 103, a sensor array 104, a controller 106, and a display system 108 (also referred to herein as a display unit). In various embodiments, the control system 102 provides assessment and display of the opening of the doors 101 under certain conditions (e.g. when the vehicle 100 is parked), for example to show possible contact between the doors 101 and one or more nearby objects when the doors 101 are opened, as forth in greater detail further below in connection with the discussion of FIGS. 2 and 3.

In one embodiment depicted in FIG. 1, vehicle 100 includes, in addition to the above-referenced doors 101, rear region 146, and control system 102, a chassis 112, a body 114, four wheels 116, an electronic system 118, a powertrain 129, a rear view mirror 140, side mirrors 142, a front grill 144, an infotainment system 148 (e.g. radio, video, navigation, and/or other system providing information and/or entertainment for a user of the vehicle 100) a steering system 150, a braking system 155, and one or more other driver input systems 160. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114. As depicted in FIG. 1, each wheel 116 comprises a wheel assembly that includes a tire as well as a wheel and related components (and that are collectively referred to as the “wheel 116” for the purposes of this Application). In various embodiments the vehicle 100 may differ from that depicted in FIG. 1. For example, in certain embodiments the number of wheels 116 may vary. By way of additional example, in various embodiments the vehicle 100 may not have a steering system, and for example may be steered by differential braking, among various other possible differences.

In the exemplary embodiment illustrated in FIG. 1, the powertrain 129 includes an actuator assembly 120 that includes an engine 130. In various other embodiments, the powertrain 129 may vary from that depicted in FIG. 1 and/or described below (e.g. in some embodiments the powertrain may include a gas combustion engine 130, while in other embodiments the powertrain 129 may include an electric motor, alone or in combination with one or more other powertrain 129 components, for example for electric vehicles, hybrid vehicles, and the like). In one embodiment depicted in FIG. 1, the actuator assembly 120 and the powertrain 129 are mounted on the chassis 112 that drives the wheels 116. In one embodiment, the engine 130 comprises a combustion engine, and is housed in an engine mounting apparatus 131. In various other embodiments, the engine 130 may comprise an electric motor and/or one or more other transmission system 129 components (e.g. for an electric vehicle).

It will be appreciated that in other embodiments, the actuator assembly 120 may include one or more other types of engines and/or motors, such as an electric motor/generator, instead of or in addition to the combustion engine. In certain embodiments, the electronic system 118 comprises an engine system that controls the engine 130 and/or one or more other systems of the vehicle 100.

Still referring to FIG. 1, in one embodiment, the engine 130 is coupled to at least some of the wheels 116 through one or more drive shafts 134. In some embodiments, the engine 130 is mechanically coupled to the transmission. In other embodiments, the engine 130 may instead be coupled to a generator used to power an electric motor that is mechanically coupled to the transmission. In certain other embodiments (e.g. electrical vehicles), an engine and/or transmission may not be necessary.

The steering system 150 is mounted on the chassis 112, and controls steering of the wheels 116. In one embodiment, the steering system may include a non-depicted steering wheel and a steering column. In various embodiments, the steering wheel receives inputs from a driver of the vehicle 100, and the steering column results in desired steering angles for the wheels 116 via the drive shafts 134 based on the inputs from the driver. In certain embodiments, an autonomous vehicle may utilize steering commands that are generated by a computer, with no involvement from the driver.

The braking system 155 is mounted on the chassis 112, and provides braking for the vehicle 100. The braking system 155 receives inputs from the driver via a non-depicted brake pedal, and provides appropriate braking via brake units (not depicted).

Other driver input systems 160 may include an acceleration input system comprising an accelerator pedal 161 that is engaged by a driver, with the engagement representative of a desired speed or acceleration of the vehicle 100. The other driver input systems 160 may also include, among other possible systems, various other inputs for various vehicle devices and/or systems, such as for the infotainment system 148, and/or one or more environmental systems, lighting units, and the like (not depicted). Similar to the discussion above regarding possible variations for the vehicle 100, in certain embodiments steering, braking, suspension, acceleration, and/or other driving features can be commanded by a computer instead of by a driver.

In one embodiment, the control system 102 is mounted on the chassis 112. As discussed above, the control system 102 provides assessment and display of the opening of the doors 101 under certain conditions (e.g. when the vehicle 100 is parked), for example to show possible contact between the doors 101 and one or more nearby objects when the doors 101 are opened, as set forth in greater detail further below in connection with the discussion of FIGS. 2 and 3.

As noted above and depicted in FIG. 1, in one embodiment the control system 102 comprises a plurality of cameras 103, a sensor array 104, a controller 106, and a display system 108. While the components of the control system 102 (including the cameras 103, the sensor array 104, the controller 106, and the display system 108) are depicted as being part of the same system, it will be appreciated that in certain embodiments these features may comprise two or more systems. In addition, in various embodiments the control system 102 may comprise all or part of, and/or may be coupled to, various other vehicle devices and systems, such as, among others, the actuator assembly 120, the electronic system 118, and/or one or more other systems of the vehicle 100.

The plurality of cameras 103 obtain images with respect to various different locations of the vehicle 100. In addition, in various embodiments, the cameras 103 also obtain images with respect to surroundings, including objects, in proximity to the vehicle 100. As depicted in one embodiment, cameras 103 are included within or proximate each of the rear view mirror 140, side mirrors 142, front grill 144, and rear region 146 (e.g. trunk 147 or rear door/hatch 111). In one embodiment, the cameras 103 comprise video cameras controlled via the controller 106. In various embodiments, the cameras 103 may also be disposed in or proximate one or more other locations of the vehicle 100.

The sensor array 104 includes various sensors (also referred to herein as sensor units) that are used for providing measurements and/or data for use by the controller 106. In various embodiments, the sensors of the sensor array 104 comprise one or more detection sensors 162, interface sensors 163, gear sensors 164, and/or wheel speed sensors 165. The detection sensors 162 (e.g. radar, lidar, sonar, machine vision, Hall Effect, and/or other sensors) detect objects in proximity to the vehicle 100. The interface sensors 163 detect a user's engagement of an interface of the vehicle 100 (e.g. a button, a knob, a display screen, and/or one or more other interfaces), for example in initiating a request for a display of the display system 108 with respect to the doors 101 of the vehicle 100. The gear sensors 164 detect a gear or transmission state of the vehicle 100 (e.g. park, drive, neutral, or reverse). The wheel speed sensors 165 measure a speed of one or more of the wheels 116 of the vehicle 100. In various embodiments, the sensor array 104 provides the measured information to the controller 106 for processing, including for generating assessments and displays pertaining to opening of the doors 101 of the vehicle 100 (including whether the doors are expected to contact any objects when opened to various positions), for example in accordance with the steps of the process 200 of FIGS. 2 and 3. It will be appreciated that in certain embodiments the cameras 103 may be considered as part of the sensor array 104.

The controller 106 is coupled to the cameras 103, the sensor array 104, and the display system 108. The controller 106 utilizes the various measurements and information from the cameras 103 and the sensor array 104, and provides assessments for opening of the doors 101 (including assessments as to whether the various doors are expected to contact any external objects when opened at one or more opening positions) using the various measurements and information, for example in accordance with the steps discussed further below in connection with the process 200 of FIGS. 2 and 3.

As depicted in FIG. 1, the controller 106 comprises a computer system. In certain embodiments, the controller 106 may also include one or more of the sensors of the sensor array 104, one or more other devices and/or systems, and/or components thereof. In addition, it will be appreciated that the controller 106 may otherwise differ from the embodiment depicted in FIG. 1. For example, the controller 106 may be coupled to or may otherwise utilize one or more remote computer systems and/or other systems, such as the electronic system 118, the infotainment system 148 of the vehicle 100, and/or one or more other systems of the vehicle 100.

In the depicted embodiment, the computer system of the controller 106 includes a processor 172, a memory 174, an interface 176, a storage device 178, and a bus 180. The processor 172 performs the computation and control functions of the controller 106, and may comprise any type of processor or multiple processors, single integrated circuits such as a microprocessor, or any suitable number of integrated circuit devices and/or circuit boards working in cooperation to accomplish the functions of a processing unit. During operation, the processor 172 executes one or more programs 182 contained within the memory 174 and, as such, controls the general operation of the controller 106 and the computer system of the controller 106, generally in executing the processes described herein, such as the process 200 described further below in connection with FIGS. 2 and 3.

The memory 174 can be any type of suitable memory. For example, the memory 174 may include various types of dynamic random access memory (DRAM) such as SDRAM, the various types of static RAM (SRAM), and the various types of non-volatile memory (PROM, EPROM, and flash). In certain examples, the memory 174 is located on and/or co-located on the same computer chip as the processor 172. In the depicted embodiment, the memory 174 stores the above-referenced program 182 along with one or more stored values 184. In certain embodiments, the stored values 184 include information regarding door geometries of the vehicle doors 101, and/or the door geometries relative to the sensor positions of the sensors of the sensor array 104. For example, in one embodiment, the relative geometry between a camera, radar sensor, or other sensor relative to the door 101 allows the door's position to be determined. Also in one embodiment, the instant center of rotation for each of the doors 101, along with each door 101's instant position, are stored in the memory 174 as stored values 184, for subsequent use in estimating the position of the doors 101 after the respective doors 101 are opened to some opening angle.

The bus 180 serves to transmit programs, data, status and other information or signals between the various components of the computer system of the controller 106. The interface 176 allows communication to the computer system of the controller 106, for example from a system driver and/or another computer system, and can be implemented using any suitable method and apparatus. In one embodiment, the interface 176 obtains the various data from the sensors of the sensor array 104. The interface 176 can include one or more network interfaces to communicate with other systems or components. The interface 176 may also include one or more network interfaces to communicate with technicians, and/or one or more storage interfaces to connect to storage apparatuses, such as the storage device 178.

The storage device 178 can be any suitable type of storage apparatus, including direct access storage devices such as hard disk drives, flash systems, floppy disk drives and optical disk drives. In one exemplary embodiment, the storage device 178 comprises a program product from which memory 174 can receive a program 182 that executes one or more embodiments of one or more processes of the present disclosure, such as the steps of the process 200 (and any sub-processes thereof) described further below in connection with FIGS. 2 and 3. In another exemplary embodiment, the program product may be directly stored in and/or otherwise accessed by the memory 174 and/or a disk (e.g., disk 186), such as that referenced below.

The bus 180 can be any suitable physical or logical means of connecting computer systems and components. This includes, but is not limited to, direct hard-wired connections, fiber optics, infrared and wireless bus technologies. During operation, the program 182 is stored in the memory 174 and executed by the processor 172.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 172) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 106 may also otherwise differ from the embodiment depicted in FIG. 1, for example in that the computer system of the controller 106 may be coupled to or may otherwise utilize one or more remote computer systems and/or other systems.

The display system 108 is coupled to the controller 106, and provides a display of the assessment of the opening of the doors 101, including whether the various doors 101 are expected to contact any external objects when the doors 101 are opened to one or more different opening positions. As depicted in FIG. 1, in one embodiment, the display system 108 is integrated as part of the rear view mirror 140 and/or infotainment system 148 in various embodiments. However, this may vary in other embodiments. Also as depicted in FIG. 1, the display system 108 comprises a display screen 191. In one embodiment, the display screen 191 provides a visual display of photographic and/or recorded video images and data from the cameras 103, via instructions provided by the processor 172, for viewing by a user within the vehicle 100. Specifically, in one embodiment, the display screen 191 provides a top-down view of the vehicle 100 along with the doors 101 thereof in relation to one or more objects that may be near the vehicle 100.

With reference to FIG. 3, an illustration is provided of an exemplary display 300 for a presentation that may be provided via the display system 108 (e.g. for viewing within the vehicle 100 via the display screen 191. As shown in FIG. 3, the exemplary display 300 includes a top-down view of the vehicle 100, including the doors 101 thereof (e.g. including side doors 110 and a rear door 111) in relation to objects 302 that are in proximity to the vehicle 100. While the objects 302 are depicted as other vehicles, it will be appreciate that various other types of objects 302 may also be detected and depicted (e.g. walls, barriers, trees, buildings, and so on).

In the depicted example, separate depictions are provided for each door 101 of the vehicle 100 at various stages of opening. In the example of FIG. 3, the rear door 111 is depicted with respect to a fully open position 341, while each side door 110 is depicted with respect to a full open position (with the relatively larger lines in the display 300) as well as two partially open (or intermediate) positions (with the relatively smaller lines). In one embodiment, as referred to herein, a partially open (or intermediate) position corresponds to a detent opening position for the door. Specifically, (i) a first depiction 310 of a driver's side front door illustrates this door at a fully open position 311 and two intermediate positions 312, 313; (ii) a second depiction 320 of a driver's side rear door illustrates this door at a fully open position 321 and two intermediate positions 322, 323; (iii) a third depiction 330 of a passenger's side front door illustrates this door at a fully open position 331 and two intermediate positions 332, 333; (iv) a fourth depiction 340 of a passenger's side rear door illustrates this door at a fully open position 341 and two intermediate positions 342, 343; and (v) a fifth depiction 350 of a rear door 111 illustrates this door at a fully open position 351. It will be appreciated that the number of doors, and/or the number of positions (e.g. the number of partially open, or intermediate, positions) may vary in other embodiments.

Indications are provided, as part of the display 300, for the various depictions of the display as to whether the respective door is expected to contact an object when opened to the particular door opening position (e.g. fully opened or partially opened). In certain embodiments, a first manner is used when the door is not expected to contact an object, and a second (different) manner is used when the door is expected to contact an object. In one embodiment, a first color (e.g. green) is used when the door is not expected to contact an object for the particular position of the particular door, whereas a second color (e.g. red) is used when the door is expected to contact an object for the particular position of the particular door. In the example depicted in FIG. 3, the second depiction indicates that the driver's side rear door will contact the object 302 if opened to the fully-opened position 321 or the second intermediate position 322 (e.g. these lines for 321 and 322 would be denoted in red), whereas this door would not contact the object in the first intermediate position 323 in which the door is opened less than the other positions 322 and 321 (e.g. the line for 323 would be depicted in green). Also in this embodiment, each of the depictions 310, 330, 340, and 350 (including positions 311, 312, 313, 331, 332, 333, 341, 342, 343, and 351) would be depicted in green, as the respective doors would not be expected to contact any objects when opened to these respective positions. Of course, the number of designations with the first color (e.g. green) versus the second color (e.g. red) in any particular example would depend on the particular configuration of the vehicle 100 with respect to nearby objects 302 for such particular example. In addition, in one embodiment, designation for the door positions would be placed at the detent opening points determined by the opening mechanism for the respective door. Accordingly, in this embodiment, this would allow the operator to know that for a particular door opening (e.g. position 323 in FIG. 3), that there would be no anticipated problem with opening the door to that point, and that the opening corresponds to a point where the door is likely to stay (or detent to) when opened. Accordingly, for example, in this embodiment, the door opening lines (e.g. 321, 322, and 323 of FIG. 3) would be placed at the respective door detent points. In various embodiments, various other different manners (other than color) can be used to illustrate whether or not the door is expected to contact an object. For example, in certain illustrative, non-limiting embodiments, dashed lines, blinking lines, thicker or thinner lines, or a star or other symbol at the end of the line, among various other possibilities, can be utilized to display whether or not the door is believed to contact an object when opened to a particular position.

Accordingly, for a vehicle parked in the particular example of the display 300 of FIG. 3, a user of the vehicle 100 could readily understand that any of the doors 101, with the exception of the driver's side rear door, can be opened freely without contacting any objects. The user can further readily understand that the driver's side rear door can be opened, but only slightly (i.e. to position 323) without contacting an object. This information can also be utilized in selecting a parking spot, or in adjusting a position of the vehicle 100 within a particular parking spot, among various other possible applications.

FIG. 2 is a flowchart of a process 200 for assessing opening of doors of a vehicle, in accordance with an exemplary embodiment. The process 200 can be implemented in connection with the vehicle 100 of FIG. 1 and the display 300 of FIG. 3, in accordance with an exemplary embodiment.

As depicted in FIG. 2, the process 200 begins at step 202. In one embodiment, the process begins when a vehicle drive or ignition cycle has begun for the vehicle (e.g. when a user enters the vehicle, when a user turns a motor or engine of the vehicle on, for example as detected via the interface sensors 163 and/or the gear sensors 164 of FIG. 1, or the like).

Camera images are obtained (step 204). In one embodiment, during step 202, the processor 172 of FIG. 1 obtains images from each of the cameras 103 of FIG. 1. Also, in various embodiments, the obtained images include photographic and/or video images from various locations of the vehicle 100 of FIG. 1, such as from the front side view mirrors 142, the front grill 144, and the rear region 146 (e.g. trunk 147 or rear door/hatch 111) of FIG. 1.

A top down view (or overhead view) is generated (step 206). In one embodiment, the processor 172 of FIG. 1 generates a top down view of the vehicle 100 using the images obtained from each of the cameras 103 of FIG. 1 (e.g. cameras 103 disposed on or proximate the front grill 144, rear region 146 (e.g. trunk 147 or rear door/hatch 111), and side mirrors 142. In one embodiment, the top down view of step 304 represents a view from directly above (or on top of) the vehicle 100, facing downward. Also in one embodiment, the top down view is generated continuously while the vehicle 100 is being driven. In addition, in one embodiment, the images are edited to produce different images corresponding to different views from different locations of the vehicle 100, and each of the images are edited and merged together to create the top down view. Moreover, in one embodiment the top down view is generated via the processor 172 of FIG. 2 using a compilation of images from each of the cameras 103 of the vehicle 100. Specifically, in one embodiment, raw images (e.g. video feed) from each wide field of view camera are sent to the processing unit (e.g. processor 172 of FIG. 1), which in turn de-warps each of the images, stitches all four images together, and creates the final top-down image. For example, in one embodiment, a front camera image (from a camera at the front of the vehicle, such as proximate the rear view mirror 140 and/or front grille 144), a left camera image (from a camera on a driver's side of the vehicle, such as on a driver's side mirror 142 of the vehicle), a right camera image (from a camera on a passenger's side of the vehicle, such as on a passenger's side mirror 142 of the vehicle), and a rear camera image (from a camera at the rear of the vehicle) are de-warped and stitched together to generate the final image representing the top-down view.

Objects are identified in proximity to the vehicle (step 208). In one embodiment, objects are detected in proximity to the vehicle using one or more radar, lidar, sonar, machine vision, Hall Effect, and/or other sensors. Also in embodiment, cameras 103 of FIG. 1 may be utilized, instead of or in addition to the object-detection sensors 162 of the sensor array 104, in detecting the objects. In certain embodiments, the objects are identified via the object-detection sensors 162 and/or cameras 103, and the identification is provided to the processor 172 of FIG. 1. In certain other embodiments, the objects are identified by the processor 172 based on information provided to the processor 172 via the object-detection sensors 162 and/or cameras 103.

Distances are determined between the objects and the vehicle (step 210). In various embodiments, distances are calculated and/or otherwise determined between the detected objects of step 208 and the vehicle 100. In certain embodiments, the distances are measured and/or otherwise determined via the object-detection sensors 162 and/or cameras 103, and the distances are provided to the processor 172 of FIG. 1. In certain other embodiments, the distances are determined by the processor 172 based on information provided to the processor 172 via the object-detection sensors 162 and/or cameras 103.

The distances are compared with a geometry for the doors (step 212). In one embodiment, a door geometry (including a door length, or opening instance) for each door is stored in the memory 174 of FIG. 1 as stored values 184 thereof (e.g. when the vehicle 100 was originally manufactured), and the geometries for the various doors are subsequently retrieved from the memory 174 by the processor 172 of FIG. 1 as part of step 212 for comparisons with the respective distances of step 210. In one embodiment, the geometry for each door includes an opening length or distance for the respective door at each of a plurality of opening positions (e.g. a fully open position as well as intermediate, or partially open positions, for example corresponding to the positions depicted in FIG. 3). In one embodiment, the comparisons are conducted for each door by the processor 172, for example as discussed below with respect to steps 218-228. In certain embodiments, the distances are compared with door geometries relative to the sensor positions of the sensors of the sensor array 104 (for example, as discussed above, in one embodiment, the relative geometry between a camera, radar sensor, or other sensor relative to the door 101 allows the door's position to be determined).

In one embodiment, a door is selected (step 214). In one embodiment, the doors 101 are selected by the processor 172 one at a time for analysis, as depicted in the exemplary embodiment of FIG. 2 (for illustrative purposes). It will be appreciated that in various embodiments the analysis of two or more doors 101, or all of the doors 101, may be conducted at or near the same time.

A first opening position is selected for the door (step 216). By way of example, the possible opening positions for a particular door may include a fully open position as well as one or more intermediate, or partially open positions (such as the different positions depicted in the exemplary embodiment of FIG. 3). Similar to the discussion above, in one embodiment, the positions are selected by the processor 172 one at a time for analysis, as depicted in the exemplary embodiment of FIG. 2 (for illustrative purposes). It will be appreciated that in various embodiments the analysis of multiple positions, and/or of one or more doors, may be conducted at or near the same time.

A determination is made as to whether the door is expected to contact the object when opened to a particular position (step 218). In one embodiment, in each iteration of step 218, the processor 172 determines whether the selected door of step 214, when opened to the selective position of step 216, is expected to contact an object. In one such embodiment, contact with an object is expected to be made when an opening distance from opening the selected door of step 214 to the selected position of step 216 is greater than or equal to the distance between the selected door and the closest object(s) to the selected door. Otherwise, if the opening distance is less than the distance to the object, contact with the object is not expected. Also in one embodiment, per the discussion above, the instant center of rotation for each of the doors 101 is used for estimating the position of the doors 101 after the respective doors 101 are opened to some opening angle.

If contact with the object is not expected (i.e., if the opening distance for the door is less than the distance between the door and the object), then a first indication is provided (step 220). In one embodiment, a first color (e.g. green) is provided with respect to a display of the selected door of step 214 with the selected position of step 216 (e.g. a green line, as depicted in FIG. 3), based on the determination that contact is not expected with an obstacle. The process then proceeds to step 224, described further below.

Conversely, if contact with the object is expected (i.e., if the opening distance for the door is greater than or equal to the distance between the door and the object), then a second indication is provided (step 222). In one embodiment, a second color (e.g. red) is provided with respect to a display of the selected door of step 214 with the selected position of step 216 (e.g. a red line, as depicted in FIG. 3), based on the determination that contact is expected with an obstacle. The process then proceeds to step 224, described directly below.

During step 224, a determination is made as to whether additional opening positions are to be analyzed for the door. In one embodiment, this determination is made by the processor 172 of FIG. 1.

If it is determined in step 224 that one or more additional opening positions (e.g. a full opening position or one or more partial opening positions) are still to be analyzed, then one such additional opening position is selected for the door (step 226). In one embodiment, this selection is made by the processor 172 of FIG. 1. Steps 218-224 then repeat for the selected opening position for the door (e.g. in determining whether contact with an object is likely).

Once it is determined in an iteration of step 224 that each of the opening positions have been analyzed, then a determination is made as to whether any additional doors are to be analyzed (step 228). In one embodiment, this determination is made by the processor 172 of FIG. 1.

If it is determined in step 228 that one or more additional doors are to be analyzed, then an additional door is selected (step 229) (e.g. by the processor 172 of FIG. 1), and steps 216-228 repeat for the selected door. Once it is determined in an iteration of step 228 that each of the doors has been analyzed (i.e. that there are no additional doors that need to be analyzed), the process proceeds to step 230, described below. Similar to the discussion above, it will be appreciated that in various embodiments the analysis of multiple positions, and/or of one or more doors, may be conducted at or near the same time.

During step 230, a determination is made as to whether or not a display condition has been satisfied. In various embodiments, the determination of step 230 comprises a determination made by the processor 172 of FIG. 1, based on information provided by one or more sensors of the sensor array 104 of FIG. 1, as to whether conditions are appropriate to display the door opening assessments of various iterations of step 218 (e.g. with the categorizations of the various iterations of steps 220, 222). In one embodiment, the condition is satisfied when a user has requested that the display be provided, for example via a user's engagement of a button, switch, touch screen display, or other user interface as detected via one or more interface sensors 163 of FIG. 1. In another embodiment, the condition is satisfied when the vehicle transmission or gear status is in a “park” mode (e.g. as detected via one or more gear sensors 164 of FIG. 1). In another embodiment, the condition is satisfied when the vehicle transmission or gear status is in a “reverse” mode (e.g. as detected via one or more gear sensors 164 of FIG. 1), provided further that a speed of the vehicle is less than a predetermined threshold (e.g. as determined via measurements provided by one or more wheel speed sensors 165 of FIG. 1), which may indicate that the vehicle is being backed up into a parking spot.

If it is determined that a vehicle display condition of step 230 is satisfied, then a display is provided (step 232). Specifically, in one embodiment, the processor 172 of FIG. 1 provides instructions for the display system 108 to display, via the display screen 191 of FIG. 1, the door opening assessments of the various iterations of step 218 (e.g. with the categorizations of the various iterations of steps 220, 222). In one embodiment, the display of step 232 is of the type of the display 300 discussed above in connection with FIG. 3, including an overhead view of the vehicle 100 along with the vehicle doors 101 and nearby objects 302, and including designations of whether the various vehicle doors 101 are expected to contact obstacles when opened at their respective opening positions (e.g. the fully opened position and one or more partially opened positions). For example, in one embodiment, smaller lines are used to designate the partially opened (or intermediate) positions (e.g. corresponding to detent opening points for the doors), while larger lines are used to designate the fully opened position for each door (e.g. as depicted in the example of FIG. 3). Also in one embodiment, the respective lines are depicted in a first color (e.g. green) if no contact is expected between the door and the object for such position, whereas the respective lines are depicted in a second color (e.g. red) if contact is expected between the door and the object for such position (e.g. as discussed above in connection with FIG. 3).

Accordingly, similar to the discussion above, in certain embodiments the display of step 232 can be utilized by a user of the vehicle 100 to ascertain (i) which of the doors can be opened fully without contacting an object, (ii) which of the doors can be opened to one or more partially opened positions without contacting an object, and (iii) which of the doors cannot be opened at all without contacting an object. Also similar to the discussion above, the displayed information can also be utilized in selecting a parking spot, or in adjusting a position of the vehicle 100 within a particular parking spot, among various other possible applications.

In certain embodiments, the display may be provided in step 232 without regard to any detection of objects and/or without regard to any determination as to whether the doors are likely to contact any objects when opened. For example, in certain embodiments, during step 232, the display may indicate the door limits based on the door geometries, without regard to any nearby objects.

In the depicted embodiment, the process returns to step 204 once the display is provided. Also in one embodiment, the process similarly returns to step 204 if it is determined in step 230 that a display condition is not satisfied. In various embodiments, the steps of the process 200 are performed continuously in various iterations (e.g. beginning in each new iteration with step 204) throughout the current vehicle drive or ignition cycle of the vehicle.

Accordingly, methods, systems, and vehicles are provided for providing assessment of door openings for vehicles. In various embodiments, determinations are made as to whether different vehicle doors can be opened to different opening positions without contacting an object. Also in various embodiments, displays are provided that include such determinations, for example for use by users of the vehicle in determining which doors to open, which parking spots to select, whether to provide an adjustment of the vehicle location within a parking spot, and/or various other possible applications.

It will be appreciated that the disclosed methods, systems, and vehicles may vary from those depicted in the Figures and described herein. For example, the vehicle 100, the control system 102, and/or various components thereof may vary from that depicted in FIG. 1 and described in connection therewith. It will similarly be appreciated that the display 300 may differ from that depicted in FIG. 3. In addition, it will be appreciated that certain steps of the process 200 may vary from those depicted in FIG. 2 and/or described above in connection therewith. It will similarly be appreciated that certain steps of the methods described above may occur simultaneously or in a different order than that depicted in FIG. 2 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

1. A method comprising:
obtaining, via one or more sensors of a vehicle, sensor data pertaining to one or more objects in proximity to the vehicle, wherein the sensor data comprises sensor data including object distances between the one or more doors and the one or more objects in proximity to the vehicle;
obtaining, from a memory of the vehicle, a door geometry for one or more doors of the vehicle, wherein the geometry includes, for each door, multiple opening distances for the door, the multiple opening distances comprising:
a fully open distance for fully opening the door to a fully open position; and
one or more partially open distances, for partially opening the door to one or more partially open positions;
determining, via a processor, using the sensor data and the door geometry, for each of the doors:
whether the door would be expected to contact one or more of the objects if the door were to be opened to the fully open position, based on the object distances and the fully open distance; and
whether the door would be expected to contact one or more of the objects if the door were to be opened to the one or more partially open positions, based on the object distances and the one or more partially open distances;
determining, via the processor, whether one or more display conditions are satisfied; and
when the one or more display conditions are satisfied, providing a display via a display system, via instructions provided by the processor, depicting an opening of the door at each of the fully open position and the one or more partially open positions, wherein for each door, the depicting of the opening of the door comprises, for each particular position of the door:
depicting the opening of the door to the particular position in a first manner indicating that the door is unlikely to contact an object when opened to the particular position, when the door is not expected to contact one or more of the objects when opened to the particular position; and
depicting the opening of the door to the particular position in a second manner, different from the first manner, indicating that the door is likely to contact an object when opened to the particular position, when the door is expected to contact one or more of the objects when opened to the particular position.

2.-3. (canceled)

4. The method of claim 1, wherein the providing of the display comprises, for each door:
depicting an opening of the door at each of the fully open position and the one or more partially open positions, in color for each position, namely, for each particular position, namely in:
a first color prior to the door being opened, when the door is expected not to contact one or more of the objects when opened to the particular position; and
a second color, different from the first color, prior to the door being opened, when the door is expected to contact one or more of the objects when opened to the particular position.

5. The method of claim 1, further comprising:
obtaining camera data for the vehicle from a plurality of cameras disposed at different respective locations on the vehicle;
generating a top-down view of the vehicle using the camera data; and
providing the display using the top-down view of the vehicle in combination with the depicted opening of the one or more doors.

6.-8. (canceled)

9. A system comprising:
one or more sensors configured to generate sensor data pertaining to one or more objects in proximity to a vehicle, wherein the sensor data comprises sensor data including object distances between the one or more doors and the one or more objects in proximity to the vehicle;
a memory configured to store a door geometry for one or more doors of the vehicle, wherein the geometry includes, for each door, multiple opening distances for the door, the multiple opening distances comprising:
a fully open distance for fully opening the door to a fully open position; and
one or more partially open distances, for partially opening the door to one or more partially open positions, wherein each of the one or more partially open positions represents the door being opened between a closed position and a fully open position;
a display system; and
a processor coupled to the one or more sensors and to the memory, the processor configured to at least facilitate:
determining using the sensor data and the door geometry, for each of the doors:
whether the door would be expected to contact one or more of the objects if the door were to be opened to the fully open position, based on the object distances and the fully open distance; and
whether the door would be expected to contact one or more of the objects if the door were to be opened to the one or more partially open positions, based on the object distances and the one or more partially open distances;
determining whether one or more display conditions are satisfied; and
when the one or more display conditions are satisfied, providing instructions for the display system to provide a display depicting an opening of the door at each of the fully open position and the one or more partially open positions, wherein for each door, the depicting of the opening of the door comprises, for each particular position of the door:
depicting the opening of the door to the particular position in a first manner indicating that the door is unlikely to contact an object when opened to the particular position, when the door is not expected to contact one or more of the objects when opened to the particular position; and
depicting the opening of the door to the particular position in a second manner, different from the first manner, indicating that the door is likely to contact an object when opened to the particular position, when the door is expected to contact one or more of the objects when opened to the particular position.

10. (canceled)

11. The system of claim 9, wherein the display system is configured to at least facilitate depicting, based on the instructions provided by the processor, for each door:
an opening of the door at each of the fully open position and the one or more partially open positions, in color for each position, namely, for each particular position, namely:
in a first color when the door is expected not to contact one or more of the objects when opened to the particular position; and
in a second color, different from the first color, when the door is expected to contact one or more of the objects when opened to the particular position.

12. The system of claim 9, further comprising:
a plurality of cameras disposed at different respective locations on the vehicle, the plurality of cameras configured to generate camera data for the vehicle;
wherein the processor is configured to at least facilitate:
generating a top-down view of the vehicle using the camera data; and
generating instructions for the display system to provide a display using the top-down view of the vehicle in combination with the opening of the one or more doors.

13.-15. (canceled)

16. A vehicle comprising:
one or more doors;
one or more sensors configured to generate sensor data pertaining to one or more objects in proximity to the vehicle, wherein the sensor data comprises sensor data including object distances between the one or more doors and the one or more objects in proximity to the vehicle;
a memory configured to store a door geometry for the one or more doors, wherein the geometry includes, for each door, multiple opening distances for the door, the multiple opening distances comprising:
a fully open distance for fully opening the door to a fully open position; and
one or more partially open distances, for partially opening the door to one or more partially open positions, wherein each of the one or more partially open conditions comprises a detent position, which the door is likely to detent to and stay at when opened, and which represents the door being partially opened between a closed position and a fully open position; and
a processor coupled to the one or more sensors and to the memory, the processor configured to at least facilitate:
determining, using the sensor data and the door geometry, for each of the doors:
whether the door would be expected to contact one or more of the objects if the door were to be opened to the fully open position, based on the object distances and the fully open distance; and
whether the door would be expected to contact one or more of the objects if the door were to be opened to the one or more partially open detent positions, based on the object distances and the one or more partially opening distances;
determining whether one or more display conditions are satisfied; and
when the one or more display conditions are satisfied, providing instructions for the display system to provide a display depicting an opening of the door at each of the fully open position and the one or more partially open positions, wherein for each door, the depicting of the opening of the door comprises, for each particular position of the door:
depicting the opening of the door to the particular position in a first manner indicating that the door is unlikely to contact an object when opened to the particular position, when the door is not expected to contact one or more of the objects when opened to the particular position; and
depicting the opening of the door to the particular position in a second manner, different from the first manner, indicating that the door is likely to contact an object when opened to the particular position, when the door is expected to contact one or more of the objects when opened to the particular position.

17. (canceled)

18. The vehicle of claim 16,
wherein the processor is configured to at least facilitate:
when the one or more display conditions are satisfied, providing instructions for the display system to provide a display depicting an opening of the door at each of the fully open position and the one or more partially open positions, wherein for each door, the depicting of the opening of the door comprises, for each particular position of the door:
depicting the opening of the door to the particular position in a first color indicating that the door is unlikely to contact an object when opened to the particular position, when the door is not expected to contact one or more of the objects when opened to the particular position; and
depicting the opening of the door to the particular position in a second color, different from the first color, indicating that the door is likely to contact an object when opened to the particular position, when the door is expected to contact one or more of the objects when opened to the particular position.

19.-20. (canceled)

21. The method of claim 1, wherein, when the one or more display conditions are satisfied, the step of providing the display comprises:
providing a display, for each particular position for each door, a different respective line segment corresponding to the particular position of the door, wherein the respective line segment for each particular position of the door is depicted:
in a first manner indicating that the door is unlikely to contact an object when opened to the particular position, when the door is not expected to contact one or more of the objects when opened to the particular position; and
in a second manner, different from the first manner, indicating that the door is likely to contact an object when opened to the particular position, when the door is expected to contact one or more of the objects when opened to the particular position.

22. The method of claim 21, wherein the step of providing the display comprises providing the display such that:
the fully open position is represented with a first line segment; and
the one or more partially open positions are each represented with a respective second line segment, wherein each of the respective second line segments are shorter than the first line segment.

23. The method of claim 21, wherein the step of providing the display comprises providing the display such that:
the respective line segment for the particular position of the door is depicted in a first color if the door is not expected to contact the object when opened to the particular position; and
the respective line segment for the particular position of the door is depicted in a second color, different from the first color, if the door is expected to contact the object when opened to the particular position.

24. The method of claim 23, wherein:
the respective line segment for the particular position of the door is depicted in green if the door is not expected to contact the object when opened to the particular position; and
the respective line segment for the particular position of the door is depicted in red if the door is expected to contact the object when opened to the particular position.

25. The method of claim 1, wherein:
the one or more partially open positions comprise a plurality of different partially open positions;
the step of obtaining the door geometry comprises obtaining, from the memory of the vehicle, the door geometry for each of the doors of the vehicle, wherein the door geometry includes, for each door, multiple opening distances for the door, the multiple opening distances comprising:
the fully open distance for fully opening the door to the fully open position; and
a plurality of partially open distances, each of the plurality of partially open distances comprising a distance for opening the door to a respective one of the plurality of partially open positions;
the step of determining whether the door would be expected to contact one or more objects comprises determining, via the processor, using the sensor data and the door geometry, for each of the doors:
whether the door would be expected to contact one or more of the objects if the door were to be opened to the fully open position, based on the object distances and the fully open distance; and
whether the door would be expected to contact one or more of the objects if the door were to be opened to each of the plurality of positions, based on the object distances and each of the plurality of partially open distances; and
when the one or more display conditions are satisfied, the step of providing the display comprises providing the display, via instructions provided by the processor, depicting the opening of the door at each of the fully open position and each of the plurality of partially open positions, wherein for each door, the depicting of the opening of the door comprises, for each of the fully open position and each of the partially open positions:
depicting the opening of the door to the particular position in the first manner indicating that the door is unlikely to contact an object when opened to the particular position, when the door is not expected to contact one or more of the objects when opened to the particular position; and
depicting the opening of the door to the particular position in a second manner, different from the first manner, indicating that the door is likely to contact an object when opened to the particular position, when the door is expected to contact one or more of the objects when opened to the particular position.

26. The method of claim 25, wherein:
the one or more partially open positions comprise a plurality of detent positions, which the door is likely to detent to and stay at when opened, and each of which represents the door being partially opened between the closed position and the fully open position;
the step of obtaining the door geometry comprises obtaining, from the memory of the vehicle, the door geometry for each door of the vehicle, wherein the door geometry includes, for each door, multiple opening distances for the door, the multiple opening distances comprising
the fully open distance for fully opening the door to the fully open position; and
a plurality of detent distances, each of the plurality of detent distances comprising a distance for opening the door to a respective one of the plurality of detent positions;
the step of determining whether the door would be expected to contact one or more objects comprises determining, via the processor, using the sensor data and the door geometry, for each of the doors:
whether the door would be expected to contact one or more of the objects if the door were to be opened to the fully open position, based on the object distances and the fully open distance; and
whether the door would be expected to contact one or more of the objects if the door were to be opened to each of the plurality of detent positions, based on the object distances and each of the plurality of detent distances; and
when the one or more display conditions are satisfied, the step of providing the display comprises providing the display, via instructions provided by the processor, depicting the opening of the door at each of the fully open position and each of the plurality of detent positions, wherein for each door, the depicting of the opening of the door comprises, for each of the fully open position and each of the detent positions:
depicting the opening of the door to the particular position with a respective line segment in the first color indicating that the door is unlikely to contact an object when opened to the particular position, when the door is not expected to contact one or more of the objects when opened to the particular position; and
depicting the opening of the door to the particular position with the respective line segment in the second color, indicating that the door is likely to contact an object when opened to the particular position, when the door is expected to contact one or more of the objects when opened to the particular position.

27. The system of claim 9, wherein, when the one or more display conditions are satisfied, the processor is configured to provide instructions for the display system to provide a display comprising, for each particular position for each door, a different respective line segment corresponding to the particular position of the door, wherein the respective line segment for each particular position of the door is depicted:
in a first manner indicating that the door is unlikely to contact an object when opened to the particular position, when the door is not expected to contact one or more of the objects when opened to the particular position; and
in a second manner, different from the first manner, indicating that the door is likely to contact an object when opened to the particular position, when the door is expected to contact one or more of the objects when opened to the particular position.

28. The system of claim 27, wherein the processor is configured to provide instructions for the display system to provide the display such that:
the fully open position is represented with a first line segment; and
the one or more partially open positions are each represented with a respective second line segment, wherein each of the respective second line segments are shorter than the first line segment.

29. The system of claim 27, wherein the processor is configured to provide instructions for the display system to provide the display such that:
the respective line segment for the particular position of the door is depicted in a first color if the door is not expected to contact the object when opened to the particular position; and
the respective line segment for the particular position of the door is depicted in a second color, different from the first color, if the door is expected to contact the object when opened to the particular position.

30. The vehicle of claim 16, wherein, when the one or more display conditions are satisfied, the processor is configured to provide instructions for the display system to provide a display comprising, for each particular position for each door, a different respective line segment corresponding to the particular position of the door, wherein the respective line segment for each particular position of the door is depicted:
in a first manner indicating that the door is unlikely to contact an object when opened to the particular position, when the door is not expected to contact one or more of the objects when opened to the particular position; and
in a second manner, different from the first manner, indicating that the door is likely to contact an object when opened to the particular position, when the door is expected to contact one or more of the objects when opened to the particular position.

31. The vehicle of claim 30, wherein the processor is configured to provide instructions for the display system to provide the display such that:
the fully open position is represented with a first line segment; and
the one or more partially open positions are each represented with a respective second line segment, wherein each of the respective second line segments are shorter than the first line segment.

32. The vehicle of claim 30, wherein the processor is configured to provide instructions for the display system to provide the display such that:
the respective line segment for the particular position of the door is depicted in a first color if the door is not expected to contact the object when opened to the particular position; and
the respective line segment for the particular position of the door is depicted in a second color, different from the first color, if the door is expected to contact the object when opened to the particular position.
